(19) United States
(12) Patent Application Publication
(10) Pub. No.: US 2025/0136495 A1
(43) Pub. Date: May 1, 2025

(54) GLASS PRODUCT, GLASS COMPOSITION, AND METHOD OF MAKING A GLASS PRODUCT

(71) Applicant: Schott AG, Mainz (DE)

(72) Inventors: Michael Hahn, Mainz (DE); Rainer Erwin Eichholz, Mainz (DE); Josef Rasp, Mainz (DE); Malte Grimm, Mainz (DE); Stefan Knoche, Mainz (DE)

(73) Assignee: Schott AG, Mainz (DE)

(21) Appl. No.: 18/707,290

(22) PCT Filed: Sep. 8, 2022
(86) PCT No.: PCT/EP2022/075014

§ 371 Date: May 3, 2024

(30) Foreign Application Priority Data
Sep. 8, 2021 (DE) 10 2021 123 303.8
Sep. 8, 2021 (EP) 21195639.9
Dec. 22, 2021 (EP) 21217184.7

(51) Int. Cl. C03C 3/118

(52) U.S. Cl. CPC C03C 3/118; C03C 2203/10

(57) ABSTRACT

The disclosure relates to a glass product or glass composition, and to a method of making a glass product. The glass composition can be manufactured without inhomogeneities in the glass melt and with sufficiently uniform and isotropic properties in the obtained products. The glass compositions further minimise and/or overcome the problem of blockage of pipes, liners, ducts or nozzles during the manufacture of high-quality glasses.

This disclosure relates to a glass product or glass composition, and to a method of making a glass product. The glass composition can be manufactured without inhomogeneities in the glass melt and with uniform and isotropic properties in the obtained products. The glass compositions further minimise and/or overcome the problem of blockage of pipes, liners, ducts or nozzles during the manufacture of high-quality glasses.

### BACKGROUND

Glass compositions and their products are encountered in many areas covering both household and industrial applications. The production of a specific glass product needs to be adapted depending on the composition, its intended application and the required quality standards it must meet.

Pharmaceutical glasses and optical glasses are examples of specialized glasses designed and tailored for specific applications and products. These specialized glasses have high melting temperatures which further distinguishes them from more common soda-lime glasses.

The industrial production of high-quality glass products remains challenging. For example, the primary demands on pharmaceutical glasses and optical glasses are a low bubble count and the absence of defects. It is common that all these high-quality glass products need to be homogeneous, uniform and isotropic with respect to their physical and chemical properties.

In order to meet these standards, high demands are placed on the industrial production of these high-quality glass products. Due to their high melting temperatures, pipes, liners, ducts or nozzles of special metals or alloys are employed which are resistant at high temperatures, e.g. above 1500° C. Platinum-rhodium (PtRh) alloys are typically employed in this context.

One particular problem during the manufacture of high-quality glasses with high melting temperatures is blockage of the mentioned pipes, liners, ducts or nozzles. This problem is believed to result from the high melting temperatures of the glass compositions. Foremost, if an element of the production apparatus is blocked, it often needs replacement which is very costly in view of the special metals or alloys employed. Additionally, operating processes may have to be interrupted and generally require more monitoring and maintenance.

Accordingly, there remains a need to design and run the industrial production of high-quality glass products in such a way that the production processes can be performed continuously, smoothly and for a sufficiently long period.

Accordingly, there remains a desire to provide a high-quality glass product and/or a glass composition which meets the above challenges and allows manufacturing without process interruptions due to blockage.

### SUMMARY OF THE DISCLOSURE

In a first aspect, the disclosure relates to a glass product or a glass composition comprising a total carbon content of less than 310 ppm, based on the weight of the carbon atoms with respect to the weight of the product or the composition, and/or comprising less than 2 bubbles having a size of 100 μm or more and a CO₂ content of more than 10% relative to the total volume of gas in the bubble, per 10 kg of glass; wherein the product or composition has a water content of 10 to 80 mmol/l, wherein a maximal contact angle at a glass/PtRh interface, is more than 122.0°, preferably more than 124.0°, measured according to DIN 51730:2007-09.

The inventors have established that an adjusted water content of 10 to 80 mmol/l in the glass composition or glass product in combination with a maximal contact angle at a glass/PtRh interface reduces the wettability of PtRh alloys with the glass melt which alloys are e.g. employed in Pt/Rh pipes, liners, ducts or nozzles, during the melting, heating and/or refining step(s) of the glass manufacture. The glass compositions according to this disclosure thus minimise and/or overcome the problem of blockage of pipes, liners, ducts or nozzles during the manufacture of high-quality glasses. The maximal contact angle is determined for a glass (cube) sample with an edge length of 2.5 mm in a measurement according to DIN 51730:2007-09. During the heating of the glass (cube) sample through the characteristic temperatures DT (softening temperature), ST (spherical temperature), HT (hemisphere temperature) and FT (flowing temperature), the left and right contact angle of the glass (cube) sample are continuously monitored. From each data curve, i.e. the data curve for the left contact angle and the right contact angle, the maximal contact angle during the heating experiment is extracted as a characteristic parameter (cf. section ‘Contact angle measurements’).

The problem of pipe blockage also has a negative influence on the manufactured glass product or glass composition. Initially, before a pipe gets fully blocked, perturbations within the glass melt stream will occur during manufacture which may lead to inhomogeneities in the glass melt and to a lack of uniform and isotropic properties in the final glass product. The glass product or glass composition according to the disclosure is of high quality and uniformity which may e.g. be evidenced by improved physical and chemical isotropic properties.

The glass product or glass composition may also have a desirably low bubble count which may be associated with or result from the adjusted water content and the maximal contact angle at the glass/PtRh interface.

In a second aspect, the disclosure relates to a method of making a glass product, comprising the steps of
melting a batch of glass raw materials in a melting tank to form a glass melt,
heating the glass raw materials and/or the glass melt using a hydrogen burner, preferably using exclusive heating by way of hydrogen burning,
refining the glass melt using a refining agent,
withdrawing the glass melt from the melting tank,
obtaining a glass product comprising a water content of 10 to 80 mmol/l,
   wherein the batch of glass raw materials comprises less than 15 wt. % carbonate.
   this disclosure thus provides a method which solves the problem of pipe blockage during the manufacture of a high-quality glass product. Advantageously, heating the glass raw materials and/or the glass melt using a hydrogen burner by partial or exclusive heating by way of hydrogen burning contributes to an adjusted and/or increased water content in the glass. This course of action also contributes to an increased contact angle which is higher than for methods relying exclusively on fossil fuel, e.g. natural gas, burning. The method according to this disclosure employs a refining step which acts synergistically with the heating and/or melting steps, and thus contributes to the glass properties and to avoiding the problem of pipe blockage during the manufacture. The type and amount of the refining agent may be chosen such that the water content in the glass product is optimised to a range between 10 to 80 mmol/l.

Without wishing to be bound by theory, it is believed that the measure of employing less than 15 wt. % carbonate in the batch of glass raw materials also has a positive bearing on the obtained properties of the glass composition and the final glass product, i.e. in relation to an increased contact angle of the obtained glass product, measured at a glass/PtRh interface. For example, the reduction of carbonate in the glass raw materials and the reduction or avoidance of fossil fuel heating contribute to a reduced emanation of CO₂ during manufacture and to a reduced amount of CO₂ and CO₂-containing bubbles in the final glass products.

### Further Aspects of this Disclosure

In one aspect, the disclosure relates to a glass product or a glass composition comprising a refining agent selected from the list of chlorides and fluorides, wherein the refining agent is present at a content of 1.00 wt. % or less, preferably comprising less than 0.60 wt. % chlorine and/or less than 0.30 wt. % fluorine, with respect to the weight of the product or composition, wherein the product or composition has a water content of 10 to 80 mmol/l, wherein a maximal contact angle between a glass/PtRh interface, is more than 122.0°, preferably more than 124.0°, measured according to DIN 51730:2007-09.

In one aspect, this disclosure relates to a glass product or a glass composition having less than 80 bubbles in a size range of from 0.1 mm to 0.2 mm per 10 kg of glass and/or less than 2 bubbles of a size larger than 0.2 mm per 10 kg of glass, wherein the product or composition has a water content of 10 to 80 mmol/l, wherein a maximal contact angle between a glass/PtRh interface, is more than 122.0°, preferably more than 124.0°, measured according to DIN 51730:2007-09.

In one aspect, this disclosure relates to a glass product or a glass composition comprising a total carbon content of less than 310 ppm, based on the weight of the carbon atoms with respect to the weight of the product or the composition, wherein the product or composition has a water content of 10 to 80 mmol/l, the glass product or the glass composition comprising a refining agent selected from the list of chlorides and fluorides, wherein the refining agent is present at a content of 1.00 wt. % or less, preferably comprising less than 0.60 wt. % chlorine and/or less than 0.30 wt. % fluorine, with respect to the weight of the product or composition.

In one aspect, this disclosure relates to a glass product or a glass composition comprising a total carbon content of less than 310 ppm, based on the weight of the carbon atoms with respect to the weight of the product or the composition, and/or comprising less than 2 bubbles having a size of 100 μm or more and a CO₂ content of more than 10% relative to the total volume of gas in the bubble, per 10 kg of glass; wherein the product or composition has a water content of 10 to 80 mmol/l, the glass product or the glass composition having less than 80 bubbles in a size range of from 0.1 mm to 0.2 mm per 10 kg of glass and/or less than 2 bubbles of a size larger than 0.2 mm per 10 kg of glass.

In one aspect, this disclosure relates to a glass product or a glass composition comprising a total carbon content of less than 310 ppm, based on the weight of the carbon atoms with respect to the weight of the product or the composition, and/or comprising less than 2 bubbles having a size of 100 μm or more and a CO₂ content of more than 10% relative to the total volume of gas in the bubble, per 10 kg of glass; wherein a maximal contact angle between a glass/PtRh interface, is more than 122.0°, preferably more than 124.0°, measured according to DIN 51730:2007-09, the glass product or the glass composition comprising a refining agent selected from the list of chlorides and fluorides, wherein the refining agent is present at a content of 1.00 wt. % or less, preferably comprising less than 0.60 wt. % chlorine and/or less than 0.30 wt. % fluorine, with respect to the weight of the product or composition.

In one aspect, this disclosure relates to a glass product or a glass composition comprising a total carbon content of less than 310 ppm, based on the weight of the carbon atoms with respect to the weight of the product or the composition, and/or comprising less than 2 bubbles having a size of 100 μm or more and a CO₂ content of more than 10% relative to the total volume of gas in the bubble, per 10 kg of glass; wherein a maximal contact angle between a glass/PtRh interface, is more than 122.0°, preferably more than 124.0°, measured according to DIN 51730:2007-09, the glass product or the glass composition having less than 80 bubbles in a size range of from 0.1 mm to 0.2 mm per 10 kg of glass and/or less than 2 bubbles of a size larger than 0.2 mm per 10 kg of glass.

In one aspect, this disclosure relates to a glass product or a glass composition comprising a total carbon content of less than 310 ppm, based on the weight of the carbon atoms with respect to the weight of the product or the composition, and/or comprising less than 2 bubbles having a size of 100 μm or more and a CO₂ content of more than 10% relative to the total volume of gas in the bubble, per 10 kg of glass; wherein the product or composition has a water content of 10 to 80 mmol/l, wherein a maximal contact angle between a glass/PtRh interface, is more than 122.0°, preferably more than 124.0°, measured according to DIN 51730:2007-09, wherein the glass product or the glass composition comprises the following components in % by weight:

| | |
|---|---|
| SiO₂ | 70.0 to 87.0 |
| B₂O₃ | 7.0 to 25.0 |
| Na₂O + K₂O | 0.5 to 15.0 |
| Al₂O₃ | 0.0 to 15.0 |
| CaO | 0.0 to 3.0 |

wherein the glass product or the glass composition comprises a refining agent selected from the list of chlorides and fluorides, wherein the refining agent is present at a content of 1.00 wt. % or less, preferably comprising less than 0.60 wt. % chlorine and/or less than 0.30 wt. % fluorine, with respect to the weight of the product or composition.

In one aspect, this disclosure relates to a glass product or a glass composition comprising a total carbon content of less than 310 ppm, based on the weight of the carbon atoms with respect to the weight of the product or the composition, and/or comprising less than 2 bubbles having a size of 100 μm or more and a CO₂ content of more than 10% relative to the total volume of gas in the bubble, per 10 kg of glass; wherein the product or composition has a water content of 10 to 80 mmol/l, wherein a maximal contact angle between a glass/PtRh interface, is more than 122.0°, preferably more than 124.0°, measured according to DIN 51730:2007-09, wherein the glass product or the glass composition comprises the following components in % by weight:

| | |
|---|---|
| SiO₂ | 70.0 to 85.0 |
| Al₂O₃ | 0.0 to 10.0 |
| B₂O₃ | 7.0 to 20.0 |
| Na₂O | 3.0 to 15.0 |
| K₂O | 0.0 to 3.0 |
| ZnO | 0.0 to 12.0 |
| TiO₂ | 0.5 to 10.0 |
| CaO | 0.0 to 2.0 |

wherein the glass product or the glass composition comprises a refining agent selected from the list of chlorides and fluorides, wherein the refining agent is present at a content of 1.00 wt. % or less, preferably comprising less than 0.60 wt. % chlorine and/or less than 0.30 wt. % fluorine, with respect to the weight of the product or composition.

### DESCRIPTION OF FIGURES

FIG. 1A shows the raw imaging data of a glass cube sample measured according to DIN 51730:2007-09. The glass was manufactured by 100% fossil fuel heating. Consecutive images are taken during the heating of the glass cube sample from which left and right contact angles of the sample are obtained and continuously monitored. Characteristic temperatures, i.e. DT (image 243; T=766° C.), ST (image 579; T=905.5° C.), HT (image 979; T=1102° C.) and FT (image 1997; T=1526° C.), were established according to DIN 51730:2007-09, sections 3.1 to 3.4, respectively.

FIG. 1B shows the raw imaging data of a glass cube sample measured according to DIN 51730:2007-09. The glass was manufactured by 100% H₂ burning with oxygen. Consecutive images are taken during the heating of the glass cube sample from which left and right contact angles of the sample are obtained and continuously monitored. Characteristic temperatures, i.e. DT (image 449; T=828° C.), ST (image 671; T=923° C.), HT (image 1079; T=1167° C.) and FT (image 1984; T=1538° C.), were established according to DIN 51730:2007-09, sections 3.1 to 3.4, respectively.

FIG. 1C shows a schematic how the left and right contact angles are obtained from the image data. The contour (1) of the heated sample is approximated with a linear fit, i.e. a tangent (2, 2′), at both the left side and the right side. The respective angles with respect to the base line (3), i.e. a (left) and a (right), are determined.

FIG. 2 shows the temperature dependence of the contact angle measurement (cf. the section ‘Contact angle measurements’) for a borosilicate glass on a PtRh10 alloy, manufactured by (a) 100% fossil fuel heating based on burning natural gas with oxygen, and (c) by 100% H₂ burning with oxygen.

### DETAILED DESCRIPTION

In one aspect, this disclosure relates to a glass product or a glass composition comprising a total carbon content of less than 310 ppm, based on the weight of the carbon atoms with respect to the weight of the product or the composition, and/or comprising less than 2 bubbles having a size of 100 μm or more and a CO₂ content of more than 10% relative to the total volume of gas in the bubble, per 10 kg of glass; wherein the product or composition has a water content of 10 to 80 mmol/l, wherein a maximal contact angle between a glass/PtRh interface, is more than 122.0°, preferably more than 124.0°, measured according to DIN 51730:2007-09.

A “glass composition” shall be understood as the chemical composition of the glass after melting a batch of glass raw materials and solidifying the melt to obtain the glass product. In addition to oxides, the “glass composition” may further comprise non-oxide refining agents, such as e.g. chlorides and/or fluorides.

In one embodiment, the glass product or the glass composition comprises a total carbon content of less than 310 ppm, based on the weight of the carbon atoms with respect to the weight of the product or the composition. In one embodiment, the glass product or the glass composition comprises a total carbon content of less than 270 ppm, less than 240 ppm, less than 200 ppm, less than 150 ppm, less than 100 ppm, less than 50 ppm, or less than 20 ppm, based on the weight of the carbon atoms with respect to the weight of the glass product or the glass composition. In one embodiment, the glass product or the glass composition comprises a total carbon content of at least 1 ppm, at least 2 ppm, at least 3 ppm, at least 4 ppm, or at least 5 ppm, based on the weight of the carbon atoms with respect to the weight of the glass product or the glass composition. In a related embodiment, the glass product or the glass composition comprises a total carbon content of from 1 to 310 ppm, from 1 to 270 ppm, from 1 to 240 ppm, from 2 to 200 ppm, from 2 to 150 ppm, from 3 to 100 ppm, from 4 to 50 ppm, or from 5 to 20 ppm, based on the weight of the carbon atoms with respect to the weight of the glass product or the glass composition. A glass product or a glass composition having a limited total carbon content as described herein advantageously may have fewer bubbles and in particular may have fewer CO₂ bubbles. Melting with hydrogen helps achieve a low carbon content in the glass composition, whereas heating with conventional gas burners will typically result in larger total carbon contents.

In one embodiment, the product or composition has a water content of 10 to 80 mmol/l. In one embodiment, the water content is less than 80 mmol/l, less than 75 mmol/l, less than 70 mmol/l, less than 65 mmol/l, or less than 60 mmol/l. In one embodiment, the water content is at least 10 mmol/l, at least 15 mmol/l, at least 20 mmol/l, at least 25 mmol/l, at least 30 mmol/l, or at least 40 mmol/l. In one embodiment, the water content is 10 to 80 mmol/l, 15 to 75 mmol/l, 20 to 70 mmol/l, 25 to 65 mmol/l, 30 to 60 mmol/l, or 40 to 60 mmol/l. In one embodiment, the product or composition has a water content of 20 to 60 mmol/l, or 40 to 55 mmol/l. The water content may be measured by IR spectrometry at the absorption maximum at about 2700 nm, wherein the absorption maximum is preferably determined on an IR absorption spectrum in the wavelength range from 2500 to 6500 nm, assuming a standard absorption coefficient of 110 I*cm/mol for water in the glass compositions according to this disclosure.

In one embodiment, the product or composition has a maximal contact angle between a glass/PtRh interface, of more than 122.0°, preferably more than 124.0°, measured according to DIN 51730:2007-09.

From the glass product, respectively the glass composition, samples were first prepared and then measured in a heating microscope according to DIN 51730:2007-09. Samples were prepared by cutting and grinding sufficiently large glass pieces into a glass cube with an edge length of 2.5 mm. During each measurement, a glass (cube) sample is continuously heated and monitored by photographic imaging, wherein the images are taken at consecutive time points. The sample temperature at each time point is measured and monitored. Image analysis provides a left contact angle and a right contact angle between the glass (cube) sample and the PtRh surface which is the result of a tangential fit to the shadow images which is related to (i.e. equated to) the baseline of the PtRh alloy interface. From the measured left contact angles and right contact angles, the characteristic temperatures DT (softening temperature), ST (spherical temperature), HT (hemisphere temperature) and FT (flowing temperature) have been obtained.

Without wishing to be bound to theory, the exact quantitative composition of the PtRh is not critical and has not been found to alter the measured contact angle when either a PtRh10 or a PtRh9.8 alloy was used. In one embodiment, the contact angle discussed herein relates to PtRh10. In another embodiment, the contact angle relates to PtRh9.8.

In one embodiment, the product or composition has a maximal contact angle between a glass/PtRh interface, which is more than 122.0°, more than 123.0°, more than 124.0°, more than 125.0°, more than 127.0°, or more than 129.0°. In one embodiment, the product or composition has a maximal contact angle between a glass/PtRh interface, which is less than 149.0°, less than 147.0°, less than 145.0°, less than 143.0°, less than 139.0°, or less than 135.0° In one embodiment, the product or composition has a maximal contact angle between a glass/PtRh interface, which is 122.0° to 149.0°, 123.0° to 147.0°, 124.0° to 145.0°, 125.0° to 143.0°, 127.0° to 139.0°, or 129.0° to 135.0°.

In one embodiment, the glass product or glass composition further comprises a refining agent selected from the list of chlorides and fluorides, wherein the refining agent is present at a content of 1.00 wt. % or less, preferably comprising less than 0.60 wt. % chlorine and/or less than 0.30 wt. % fluorine, with respect to the weight of the product or composition.

Advantageously, chlorides and fluorides may be used as a (re) fining agent in order to adjust the water content in the glass composition and to remove emanating gas bubbles from the glass melt. It is further advantageous to reduce the amount of chlorides and fluorides in the glass melt in order to reduce volatile species emanating from the glass melt by sublimation.

In one embodiment, the refining agent is selected from the list of NaCl, KCl, NaF and KF, wherein the refining agent is present at a content of 1.00 wt. % or less, with respect to the weight of the product or composition.

In one embodiment, the refining agent selected from the list of chlorides and fluorides is present at a content of 1.0 wt. % or less, 0.75 wt. % or less, 0.50 wt. % or less, 0.40 wt. % or less, 0.30 wt. % or less, or 0.20 wt. % or less. In one embodiment, the refining agent selected from the list of chlorides and fluorides is present at a content of 0.01 wt. % or more, 0.02 wt. % or more, 0.03 wt. % or more, 0.05 wt. % or more, 0.07 wt. % or more, or 0.10 wt. % or more. In one embodiment, the refining agent selected from the list of chlorides and fluorides is present at a content of 0.01 wt. % to 1.0 wt. %, 0.02 wt. % to 0.75 wt. %, 0.03 wt. % to 0.50 wt. %, 0.05 wt. % to 0.40 wt. %, 0.07 wt. % to 0.30 wt. %, or 0.10 wt. % to 0.20 wt. %, with respect to the weight of the product or composition.

In one embodiment, the refining agent is selected from the list of NaCl, KCl, NaF and KF, wherein the refining agent is present at a content of 0.01 wt. % to 1.0 wt. %, 0.02 wt. % to 0.75 wt. %, 0.03 wt. % to 0.50 wt. %, 0.05 wt. % to 0.40 wt. %, 0.07 wt. % to 0.30 wt. %, or 0.10 wt. % to 0.20 wt. %, with respect to the weight of the product or composition.

In one embodiment, the glass product or glass composition comprises less than 0.70 wt. % chlorine, less than 0.60 wt. % chlorine, less than 0.50 wt. % chlorine, less than 0.40 wt. % chlorine, less than 0.30 wt. % chlorine, less than 0.20 wt. % chlorine, or less than 0.15 wt. % chlorine. In one embodiment, the glass product or glass composition comprises 0.005 wt. % chlorine or more, 0.01 wt. % chlorine or more, 0.02 wt. % chlorine or more, 0.03 wt. % chlorine or more, 0.04 wt. % chlorine or more, or 0.05 wt. % chlorine or more. In one embodiment, the glass product or glass composition comprises 0.005 wt. % to 0.60 wt. % chlorine, 0.01 wt. % to 0.50 wt. % chlorine, 0.02 wt. % to 0.40 wt. % chlorine, 0.03 wt. % to 0.30 wt. % chlorine, 0.04 wt. % to 0.20 wt. % chlorine, or 0.05 wt. % to 0.15 wt. % chlorine.

In one embodiment, the glass product or glass composition comprises less than 0.30 wt. % fluorine, less than 0.25 wt. % fluorine, less than 0.20 wt. % fluorine, less than 0.15 wt. % fluorine, or less than 0.10 wt. % fluorine. In one embodiment, the glass product or glass composition comprises 0.005 wt. % fluorine or more, 0.01 wt. % fluorine or more, 0.02 wt. % fluorine or more, 0.03 wt. % fluorine or more, or 0.04 wt. % fluorine or more. In one embodiment, the glass product or glass composition comprises 0.005 wt. % to 0.30 wt. % fluorine, 0.01 wt. % to 0.25 wt. % fluorine, 0.02 wt. % to 0.20 wt. % fluorine, 0.03 wt. % to 0.15 wt. % fluorine, or 0.04 wt. % to 0.10 wt. % fluorine.

It is advantageous to reduce the fluorine content in the glass composition. At large fluorine concentrations, the surface tension of the glass melt may be reduced which increases the wetting behaviour of the glass (melt) composition.

An adjusted and/or reduced fluorine content in the glass composition may thus further assist in reducing the wettability of the glass with PtRh alloys employed in Pt/Rh pipes, liners, ducts or nozzles, during the melting, heating and/or refining step(s) of the glass manufacture. An adjusted and/or reduced fluorine content is thus believed to assist in minimising and/or overcoming the problem of blockage of pipes, liners, ducts or nozzles during the manufacture of high-quality glasses.

In one embodiment, the glass product or glass composition has less than 80 bubbles in a size range of from 0.1 mm to 0.2 mm per 10 kg of glass and/or less than 2 bubbles of a size larger than 0.2 mm per 10 kg of glass.

A “bubble” is a gaseous inclusion within the glass or the glass melt, wherein the size or size range refers to the diameter of a sphere with a volume equivalent that of the gaseous inclusion, respectively the bubble. Whenever in this description reference is made to “bubble” it can be understood as gas bubble in its broadest meaning.

In one embodiment, the glass product or glass composition has less than 80 bubbles, less than 60 bubbles, less than 40 bubbles, or less than 20 bubbles, in a size range of from 0.1 mm to 0.2 mm per 10 kg of glass. In one embodiment, the glass product or glass composition has 0 bubbles, at least 2 bubbles, at least 5 bubbles, or at least 10 bubbles, in a size range of from 0.1 mm to 0.2 mm per 10 kg of glass. In one embodiment, the glass product or glass composition has 0 to 80 bubbles, 2 to 60 bubbles, 5 to 40 bubbles, or 10 to 20 bubbles, in a size range of from 0.1 mm to 0.2 mm per 10 kg of glass. The indication of a number of bubbles per 10 kg of glass does not mean that the glass product must have a mass of at least 10 kg. Thus, the number of bubbles per mass unit may be measured in smaller samples as well, e.g. a sample of 1 kg or 100 g.

In one embodiment, the glass product or glass composition has less than 2 bubbles of a size larger than 0.2 mm per 10 kg of glass, or 0 bubbles of a size larger than 0.2 mm per 10 kg of glass.

In one embodiment, the glass product or glass composition has 0 to 80 bubbles, 2 to 60 bubbles, 5 to 40 bubbles, or 10 to 20 bubbles, in a size range of from 0.1 mm to 0.2 mm per 10 kg of glass and less than 2 bubbles of a size larger than 0.2 mm per 10 kg of glass.

In one embodiment, the glass product or glass composition has 0 to 80 bubbles, 2 to 60 bubbles, 5 to 40 bubbles, or 10 to 20 bubbles, in a size range of from 0.1 mm to 0.2 mm per 10 kg of glass and 0 bubbles of a size larger than 0.2 mm per 10 kg of glass.

For example, the glass product may comprise less than 2 bubbles having a size of 100 μm or more and a CO₂ content of more than 5% relative to the total volume of gas in the bubble, per 10 kg of glass. In certain embodiments, the glass product may be free of bubbles having a size of 100 μm or more and a CO₂ content of more than 5% relative to the total volume of gas in the bubble, per 10 kg of glass. For example, the glass product may comprise less than 2 bubbles having a size of 100 μm or more and a CO₂ content of more than 10% relative to the total volume of gas in the bubble, per 10 kg of glass. In certain embodiments, the glass product may be free of bubbles having a size of 100 μm or more and a CO₂ content of more than 10% relative to the total volume of gas in the bubble, per 10 kg of glass.

In one embodiment, the glass product or glass composition exhibits a viscosity of 10² dPas at a temperature above 1580° C.

The viscosity may be measured using a rotational viscosimeter, e.g. as described in DIN ISO 7884-2:1998-2. The dependence of the viscosity on the temperature is described according to the VFT equation (Vogel-Fulcher-Tammann).

In one embodiment, the glass product or glass composition exhibits a viscosity of 10² dPas at a temperature above 1580° C., above 1600° C., above 1620° C., or above 1650° C. In one embodiment, the glass product or glass composition exhibits a viscosity of 10² dPas at a temperature at 1800° C. or less, 1780° C. or less, above 1750° C. or less, or 1720° C. or less. In one embodiment, the glass product or glass composition exhibits a viscosity of 10² dPas at a temperature of 1580° C. to 1800° C., 1600° C. to 1780° C., 1620° C. to 1750° C., or 1650° C. to 1720° C.

In one embodiment, the hemisphere temperature of the glass product or glass composition is 1000 to 1300° C., measured according to DIN 51730:2007-09.

In one embodiment, the hemisphere temperature of the glass product or glass composition is 1000° C. or more, 1010° C. or more, 1020° C. or more, 1030° C. or more, 1050° C. or more, 1070° C. or more, or 1090° C. or more. In one embodiment, the hemisphere temperature of the glass product or glass composition is 1300° C. or less, 1275° C. or less, 1250° C. or less, 1225° C. or less, 1200° C. or less, or 1180° C. or less.

In one embodiment, the hemisphere temperature of the glass product or glass composition is 1000° C. to 1300° C., 1020° C. to 1275° C., 1030° C. to 1250° C., 1050° C. to 1225° C., 1070° C. to 1200° C., or 1090° C. to 1180° C.

In one embodiment, the glass product or glass composition comprises less than 0.40 mg/l CaO, or less than 0.35 mg/l CaO, in an eluate prepared and analysed according to ISO 720:1985. In one embodiment, the glass product or glass composition comprises 0.10 mg/l CaO or more, or 0.20 mg/l CaO or more, in an eluate prepared and analysed according to ISO 720:1985. In one embodiment, the glass product or glass composition comprises 0.10 mg/l to 0.40 mg/l CaO, or 0.20 mg/l to 0.35 mg/l mg/l CaO, in an eluate prepared and analysed according to ISO 720:1985.

In one embodiment, the glass product or glass composition has a CO₂ solubility in a glass melt of less than 5·10¹⁹ molecules CO₂ bar⁻¹ cm⁻³ at 1100° C., and/or has a temperature dependence of the CO₂ solubility in the glass melt which exceeds 2·10¹⁴ molecules CO₂ bar⁻¹ cm⁻³ K⁻¹ in a temperature range of from 1000 to 1600° C.

In one embodiment, the glass product or glass composition has a CO₂ solubility in a glass melt of less than 5·10¹⁹ molecules CO₂ bar⁻¹ cm⁻³ glass melt at 1100° C., less than 4·10¹⁹ molecules CO₂ bar⁻¹ cm⁻³ glass melt at 1100° C., less than 3·10¹⁹ molecules CO₂ bar⁻¹ cm⁻³ glass melt at 1100° C., or less than 2·10¹⁹ molecules CO₂ bar⁻¹ cm⁻³ glass melt at 1100° C. In one embodiment, the glass product or glass composition has a CO₂ solubility in a glass melt of at least 1·10¹⁵ molecules CO₂ bar⁻¹ cm⁻³ glass melt at 1100° C., at least 1·10¹⁶ molecules CO₂ bar⁻¹ cm⁻³ glass melt at 1100° C., or at least 1·10¹⁷ molecules CO₂ bar⁻¹ cm⁻³ glass melt at 1100° C. In one embodiment, the glass product or glass composition has a CO₂ solubility in a glass melt of from 1·10¹⁵ to 5·10¹⁹ molecules CO₂ bar⁻¹ cm⁻³ glass melt at 1100° C., 1·10¹⁶ to 4·10¹⁹ molecules CO₂ bar⁻¹ cm⁻³ glass melt at 1100° C., or 1·10¹⁷ to 3·10¹⁹ molecules CO₂ bar⁻¹ cm⁻³ glass melt at 1100° C.

In one embodiment of this disclosure, the glass product or the glass composition is characterised by a temperature dependence of the CO₂ solubility of the composition in a temperature range. The temperature range includes temperatures where the product or the composition is in the form of a glass melt, and thus describes a property of the product or the composition in that range.

In one embodiment, the glass product or glass composition has a temperature dependence of the CO₂ solubility in the glass melt which exceeds 2·10¹⁴ molecules CO₂ bar⁻¹ cm⁻³ K⁻¹ in a temperature range of from 1000 to 1600° C.

In one embodiment of the glass product or the glass composition, a temperature dependence of the CO₂ solubility may exceed 2·10¹⁴ molecules CO₂ bar⁻¹ cm⁻³ K⁻¹ in a temperature range of from 1000 to 1600° C. In a further embodiment, the temperature dependence of the CO₂ solubility may exceed 5·10¹⁴ molecules CO₂ bar⁻¹ cm⁻³ K⁻¹ in a temperature range of from 1000 to 1600° C., or may exceed 1·10¹⁵ molecules CO₂ bar⁻¹ cm⁻³ K⁻¹ in a temperature range of from 1000 to 1600° C. In a related embodiment, the temperature dependence of the CO₂ solubility may be less than 1·10¹⁸ molecules CO₂ bar⁻¹ cm⁻³ K⁻¹ in a temperature range of from 1000 to 1600° C., less than 1·10¹⁷ molecules CO₂ bar⁻¹ cm⁻³ K⁻¹ in a temperature range of from 1000 to 1600° C., or less than 5·10¹⁶ molecules CO₂ bar⁻¹ cm⁻³ K⁻¹ in a temperature range of from 1000 to 1600° C.

In related embodiments, the temperature dependence of the CO₂ solubility may be between 2·10¹⁴ molecules CO₂ bar⁻¹ cm⁻³ K⁻¹ and 1·10¹⁸ molecules CO₂ bar⁻¹ cm⁻³ K⁻¹ in a temperature range of from 1000 to 1600° C., between 5·10¹⁴ molecules CO₂ bar⁻¹ cm⁻³ K⁻¹ and 1·10¹⁷ molecules CO₂ bar⁻¹ cm⁻³ K⁻¹ in a temperature range of from 1000 to 1600° C., or between 1·10¹⁵ molecules CO₂ bar⁻¹ cm⁻³ K⁻¹ and 5·10¹⁶ molecules CO₂ bar⁻¹ cm⁻³ K⁻¹ in a temperature range of from 1000 to 1600° C. This temperature dependence of the CO₂ solubility is advantageous as it provides for optimal degassing of the glass melt in the temperature range of from 1300 to 1650° C., and thus contributes to a low bubble count in the glass product or the glass composition.

In this context, the skilled person knows and appreciates that the CO₂ solubility decreases with increasing temperatures. Depending on the viscosity-temperature behaviour of the glass melt, it is also advantageous that the temperature dependence of the CO₂ solubility exceeds 2·10¹⁴ molecules CO₂ bar⁻¹ cm⁻³ K⁻¹ in a temperature range of from 1000 to 1600° C. The composition of the glass melt may be engineered in such a way as to provide for a lowered viscosity in a temperature range of from 1300 to 1650° C., which provides for more efficient and faster degassing of the glass melt in this temperature range.

### Oxide Refining Agents

In one embodiment, the glass product or glass composition comprises less than 500 ppm SnO₂, less than 100 ppm As₂O₃, and/or less than 100 ppm Sb₂O₃.

In one embodiment, the glass product or glass composition comprises less than 500 ppm SnO₂, less than 200 ppm SnO₂, less than 100 ppm SnO₂, or less than 50 ppm SnO₂. In one embodiment, the glass product or glass composition comprises at least 1 ppm SnO₂, at least 5 ppm SnO₂, at least 10 ppm SnO₂, or at least 20 ppm SnO₂. In one embodiment, the glass product or glass composition comprises at least 1 to 500 ppm SnO₂, 5 to 200 ppm SnO₂, 10 to 100 ppm SnO₂, or 20 to 50 ppm SnO₂.

In one embodiment, the glass product or glass composition comprises less than 100 ppm As₂O₃, less than 50 ppm As₂O₃, less than 20 ppm As₂O₃, or less than 10 ppm As₂O₃. In one embodiment, the glass product or glass composition comprises at least 1 ppm As₂O₃, at least 2 ppm As₂O₃, at least 3 ppm As₂O₃, or at least 5 ppm As₂O₃. In one embodiment, the glass product or glass composition comprises 1 to 100 ppm As₂O₃, 2 to 50 ppm As₂O₃, 3 to 20 ppm As₂O₃, or 5 to 10 ppm As₂O₃.

In one embodiment, the glass product or glass composition comprises less than 100 ppm Sb₂O₃, less than 50 ppm Sb₂O₃, less than 20 ppm Sb₂O₃, or less than 10 ppm Sb₂O₃. In one embodiment, the glass product or glass composition comprises at least 1 ppm Sb₂O₃, at least 2 ppm Sb₂O₃, at least 3 ppm Sb₂O₃, or at least 5 ppm Sb₂O₃. In one embodiment, the glass product or glass composition comprises 1 to 100 ppm Sb₂O₃, 2 to 50 ppm Sb₂O₃, 3 to 20 ppm Sb₂O₃, or 5 to 10 ppm Sb₂O₃.

In one embodiment, the glass product or glass composition comprises less than 50 ppm SnO₂, less than 10 ppm As₂O₃ and/or less than 10 ppm Sb₂O₃.

In one embodiment, the glass product or glass composition comprises 1 to 500 ppm SnO₂, 1 to 100 ppm As₂O₃ and/or 1 to 100 ppm Sb₂O₃.

In one embodiment, the glass product or glass composition comprises 1 to 50 ppm SnO₂, 1 to 10 ppm As₂O₃ and/or 1 to 10 ppm Sb₂O₃.

In one embodiment, the glass composition is essentially free of As₂O₃ and Sb₂O₃. Advantageously, the oxide refining agents As₂O₃ and Sb₂O₃ are essentially not present in the compositions in order to reduce the environmental burden associated with the toxic heavy metals As and Sb.

If this description refers to a glass composition which is essentially free of a component or does not contain a certain component, or includes the hypothetical case of 0 weight % of that component, it is to be understood that this component may at most be present as an impurity. This means that it is not added in significant quantities and that it is not added intentionally. The term component refers to the elemental species or any molecule, whichever is applicable, containing the element. Non-essential amounts are to be understood as less than 100 ppm, preferably less than 50 ppm, and most preferably less than 10 ppm, based on the weight percentage with respect to all intentionally added components.

Where reference is made to “ppm”, this should be understood as ‘weight/weight’ (w/w).

### Components of the Glass Product or Glass Composition

In one embodiment, the glass product or glass composition comprises the following components in % by weight

| | |
|---|---|
| SiO₂ | 70.0 to 87.0 |
| B₂O₃ | 7.0 to 25.0 |
| Al₂O₃ | 0.0 to 15.0 |

In one embodiment, the glass product or glass composition comprises the following components in % by weight

| | |
|---|---|
| SiO₂ | 70.0 to 87.0 |
| B₂O₃ | 7.0 to 25.0 |
| Na₂O + K₂O | 0.5 to 15.0 |
| Al₂O₃ | 0.0 to 15.0 |
| CaO | 0.0 to 3.0 |

In one embodiment, the glass product or glass composition comprises the following components in % by weight

| | |
|---|---|
| SiO₂ | 70.0 to 85.0 |
| Al₂O₃ | 0.0 to 15.0 |
| B₂O₃ | 7.0 to 20.0 |
| Na₂O | 3.0 to 15.0 |
| K₂O | 0.0 to 3.0 |
| ZnO | 0.0 to 12.0 |
| TiO₂ | 0.5 to 10.0 |
| CaO | 0.0 to 2.0 |

Where reference is made to a “glass composition”, it is to be understood as the oxide composition of the glass (product) after melting the batch of glass raw materials and solidifying the melt to obtain a glass product. This means that any volatile components are in the gaseous state and that the metals and metalloids are present in the glass compositions as oxides, chlorides and/or fluorides. In other words, the “glass composition” is the combination of oxides, chlorides and/or fluorides that can be obtained by melting a glass product and/or glass article.

The glass composition may be a borosilicate or an alumino-borosilicate glass composition.

The following embodiments relate to the glass composition as such as well as the glass products according to this disclosure.

The glass composition may contain alkali metal oxides, such as e.g. Na₂O, and K₂O, in amounts of less than 20.0% by weight, less than 15% by weight, less than 12% by weight, or less than 10% by weight. In alternative embodiments, the amount of alkali metal oxides in the glass composition may be at least 1.0% by weight, at least 3.0% by weight, or at least 5.0% by weight.

In one embodiment, the glass composition may comprise 1.0 wt. % Na₂O or more, 4.0 wt. % Na₂O or more, 5.0 wt. % Na₂O or more, 6.0 wt. % Na₂O or more, or 7.0 wt. % Na₂O or more. In one embodiment, the glass composition may comprise 15.0 wt. % Na₂O or less, 14.0 wt. % Na₂O or less, 13.0 wt. % Na₂O or less, 12.0 wt. % Na₂O or less, or 10.0 wt. % Na₂O or less. In one embodiment, the glass composition may comprise 1.0 to 15.0 wt. % Na₂O, 4.0 to 14.0 wt. % Na₂O, 5.0 to 12.0 wt. % Na₂O, 6.0 to 11.0 wt. % Na₂O, or 7.0 to 10.0 wt. % Na₂O.

In one embodiment, the glass composition may comprise 0.0 wt. % K₂O or more, 0.1 wt. % K₂O or more, 0.2 wt. % K₂O or more, 0.4 wt. % K₂O or more, or 0.5 wt. % K₂O or more. In one embodiment, the glass composition may comprise 3.0 wt. % K₂O or less, 2.5 wt. % K₂O or less, 2.0 wt. % K₂O or less, 1.5 wt. % K₂O or less, or 1.0 wt. % K₂O or less. In one embodiment, the glass composition may comprise 0.0 to 3.0 wt. % K₂O, 0.1 to 2.5 wt. % K₂O, 0.2 to 2.0 wt. % K₂O, 0.4 to 1.5 wt. % K₂O, or 0.5 to 1.0 wt. % K₂O.

The glass composition may contain alkali earth metal oxides, such as e.g. MgO, CaO, BaO, in amounts of less than 5.0% by weight, less than 4.0% by weight, less than 3.0% by weight, less than 2.0% by weight, or less than 1.0% by weight. In alternative embodiments, the amount of alkali earth metal oxides in the glass composition may be at least 0.1% by weight, at least 0.2% by weight, at least 0.3% by weight, at least 0.4% by weight, or at least 0.5% by weight. In one embodiment, the amount of alkali earth metal oxides in the glass composition may be 0.1 to 5.0% by weight, 0.2 to 4.0% by weight, 0.3 to 3.0% by weight, 0.4 to 2.0% by weight, or 0.5 to 1.0% by weight.

In one embodiment, the glass composition may comprise 0.0 wt. % CaO or more, 0.2 wt. % CaO or more, 0.5 wt. % CaO or more, or 1.0 wt. % CaO or more. In one embodiment, the glass composition may comprise 3.5 wt. % CaO or less, 3.0 wt. % CaO or less, 2.8 wt. % CaO or less, 2.5 wt. % CaO or less, or 2.0 wt. % CaO or less. In one embodiment, the glass composition may comprise 0.0 to 3.5 wt. % CaO, 0.2 to 2.8 wt. % CaO, 0.5 to 2.5 wt. % CaO, or 1.0 to 2.0 wt. % CaO.

In one embodiment, the glass composition may comprise 0.0 wt. % BaO or more, 0.2 wt. % BaO or more, 0.5 wt. % BaO or more, or 1.0 wt. % BaO or more. In one embodiment, the glass composition may comprise 3.0 wt. % BaO or less, 2.8 wt. % BaO or less, 2.5 wt. % BaO or less, or 2.0 wt. % BaO or less. In one embodiment, the glass composition may comprise 0.0 to 3.0 wt. % BaO, 0.2 to 2.8 wt. % BaO, 0.5 to 2.5 wt. % BaO, or 1.0 to 2.0 wt. % BaO.

The glass composition may contain SiO₂ in an amount of at least 70.0% by weight, at least 71.0% by weight, at least 72.0% by weight, at least 73.0% by weight, or at least 74.0% by weight. In one embodiment, the amount of SiO₂ may be 87.0% by weight or less, 85.0% by weight or less, 82.5% by weight or less, or 80.0% by weight or less. In one embodiment, the glass composition may comprise 70.0 to 87.5 wt. % SiO₂, 71.0 to 85.0 wt. % SiO₂, 72.0 to 82.5 wt. % SiO₂, or 73.0 to 80.0 wt. % SiO₂.

The glass compositions may comprise Al₂O₃ in an amount of at least 0.0% by weight, at least 1.5% by weight, 3.0% by weight, or 4.0% by weight. The glass compositions may comprise Al₂O₃ in an amount of 15.0% by weight or less, 12.5% by weight or less, 10.0% by weight or less, or 8.0% by weight or less. In one embodiment, the glass composition may comprise 0.0 to 15.0 wt. % Al₂O₃, 1.5 to 12.5 wt. % Al₂O₃, 3.0 to 10.0 wt. % Al₂O₃, or 4.0 to 8.0 wt. % Al₂O₃.

The glass compositions may comprise B₂O₃ in an amount at least 7.0% by weight, at least 7.5% by weight, at least 8.0% by weight, at least 8.5% by weight, at least 9.0% by weight, at least 9.5% by weight, or at least 10.0% by weight. The amount of B₂O₃ may be up to 25.0% by weight, up to 22.5% by weight, up to 20.0% by weight, up to 19.0% by weight, up to 17.5% by weight, up to 16.5% by weight, up to 15.0% by weight, up to 13.5% by weight, or up to 12.0% by weight. In one embodiment, the glass composition comprises 7.0 to 25.0 wt. % B₂O₃, 7.5 to 22.5 wt. % B₂O₃, 8.0 to 20.0 wt. % B₂O₃, 8.5 to 19.0 wt. % B₂O₃, 9.0 to 17.5 wt. % B₂O₃, 9.5 to 16.5 wt. % B₂O₃, 10.0 to 15.0 wt. % B₂O₃, 10.0 to 13.5 wt. % B₂O₃, or 10.0 to 12.0 wt. % B₂O₃.

Many highly viscous glass compositions contain significant amounts of SiO₂ and B₂O₃. Optionally, the glass compositions have a total content of SiO₂ and B₂O₃ of at least 77.0% by weight, at least 78.0% by weight, at least 80.0% by weight, or at least 82.0% by weight. The total amount of SiO₂ and B₂O₃ may be limited to not more than 93.5% by weight, up to 90.0% by weight, or up to 87.5% by weight. Optionally, the amount of SiO₂ and B₂O₃ may range from 77.0% to 93.5% by weight, from 80.0% to 90.0% by weight, or from 82.0% to 87.5% by weight.

In one embodiment, the glass composition may comprise 0.0 wt. % TiO₂ or more, 0.5 wt. % TiO₂ or more, 1.0 wt. % TiO₂ or more, or 2.0 wt. % TiO₂ or more. In one embodiment, the glass composition may comprise 10.0 wt. % TiO₂ or less, 9.0 wt. % TiO₂ or less, 8.0 wt. % TiO₂ or less, or 6.0 wt. % TiO₂ or less. In one embodiment, the glass composition may comprise 0.0 to 10.0 wt. % TiO₂, 0.5 to 9.0 wt. % TiO₂, 1.0 to 8.0 wt. % TiO₂, or 2.0 to 6.0 wt. % TiO₂.

In one embodiment, the glass composition may be a borosilicate glass comprising the following components in % by weight:

| | |
|---|---|
| SiO₂ | 70.0 to 87.0 |
| B₂O₃ | 7.0 to 25.0 |
| Na₂O + K₂O | 0.5 to 9.0 |
| Al₂O₃ | 4.0 to 8.0 |
| CaO | 0.0 to 3.0 |

In one embodiment, the glass composition may be a borosilicate glass comprising the following components in % by weight:

| | |
|---|---|
| SiO₂ | 70.0 to 80.0 |
| Al₂O₃ | 4.0 to 8.0 |
| B₂O₃ | 7.0 to 15.0 |
| Na₂O | 1.0 to 15.0 |
| K₂O | 0.0 to 3.0 |

In a specific embodiment, the glass composition may be a borosilicate glass comprising the following components in % by weight:

| | |
|---|---|
| SiO₂ | 70.0 to 80.0, or 71.0 to 77.0 |
| Al₂O₃ | 0.0 to 8.0, or 4.0 to 8.0 |
| B₂O₃ | 9.0 to 15.0, or 9.0 to 12.0 |
| Na₂O | 5.5 to 8.0 |
| K₂O | 0.0 to 1.0, or 0.1 to 0.5 |
| CaO | 0.0 to 3.0, or 0.0 to 1.5 |
| BaO | 0.0 to 1.5 |
| F | 0.0 to 0.3 |
| Cl | 0.0 to 0.3 |
| MgO + CaO + | 0.0 to 2.0 |
| BaO + SrO | |

In one embodiment, the glass product is a sheet, a wafer, a plate, a tube, a rod, an ingot or a block.

### Method of Making a Glass Product

In another aspect, this disclosure relates to a method of making a glass product, comprising the steps of
melting a batch of glass raw materials in a melting tank to form a glass melt,
heating the glass raw materials and/or the glass melt using a hydrogen burner, preferably using exclusive heating by way of hydrogen burning,
refining the glass melt using a refining agent,
withdrawing the glass melt from the melting tank,
obtaining a glass product comprising a water content of 10 to 80 mmol/l,
   wherein the batch of glass raw materials comprises less than 15 wt. % carbonate.

This disclosure thus provides a method which reduces the problem of pipe blockage during the manufacture of a high-quality glass product. Advantageously, heating the glass raw materials and/or the glass melt using a hydrogen burner by partial or exclusive heating by way of hydrogen burning contributes to an adjusted and/or increased water content in the glass. This course of action also contributes to an advantageously increased contact angle which is higher than for methods relying exclusively on burning of fossil fuel, e.g. natural gas. The method according to this disclosure employs a refining step which acts synergistically with the heating and/or melting steps, and thus contributes to the glass properties and to avoiding the problem of pipe blockage during the manufacture. The type and amount of the refining agent may be chosen such that the water content in the glass product is optimised to a range between 10 to 80 mmol/l.

Without wishing to be bound by theory, it is believed that the measure of employing less than 15 wt. % carbonate in the batch of glass raw materials also has a positive bearing on the obtained properties of the glass composition and the final glass product, i.e. in relation to an increased contact angle of the obtained glass product, measured at a glass/PtRh interface. For example, the reduction of carbonate in the glass raw materials and the reduction or avoidance of fossil fuel heating contribute to a reduced emanation of CO₂ during manufacture and to a reduced amount of CO₂ in the final glass products.

The step of melting a batch of glass raw materials in a melting tank to form a glass melt, and/or the step of heating the glass raw materials and/or the glass melt using a hydrogen burner is optionally carried out by direct heating without flame contact, or alternatively by direct heating where the flame is in the vicinity of the glass raw materials or the glass melt. A “glass melt” is a volume of a batch of glass raw materials that has a viscosity of less than 107.6 dPas.

In one embodiment of the method, heating the glass raw materials and/or the glass melt using a hydrogen burner comprises burning a mixture of fossil fuel gas and hydrogen (H₂), either with air or with an oxygen containing gas. In one embodiment, the mixture of fossil fuel gas and hydrogen comprises at least 10 wt. % hydrogen, at least 20 wt. % hydrogen, at least 50 wt. % hydrogen, or at least 75 wt. % hydrogen. In one embodiment, the mixture of fossil fuel gas and hydrogen comprises 100 wt. % hydrogen or less, 99 wt. % hydrogen or less, 95 wt. % hydrogen or less, or 90 wt. % hydrogen or less. In one embodiment, the mixture of fossil fuel gas and hydrogen comprises 10 to 100 wt. % hydrogen, 20 to 99 wt. % hydrogen, 50 to 95 wt. % hydrogen, or 75 to 90 wt. % hydrogen. The skilled person, having the benefit of this disclosure, knows how to quantitatively adjust the mixture between fossil fuel gas and hydrogen in order to achieve a desirable water content in the glass and/or a desirable carbon content in the glass. Likewise, the skilled person makes a conscious choice between either air or oxygen, as an oxidant, in order to achieve sufficiently high temperatures upon burning the fuel (fossil fuel or hydrogen).

In one embodiment of the method, heating the glass raw materials and/or the glass melt using a hydrogen burner comprises burning a hydrogen containing gas with an oxygen containing gas. Heating with an oxygen containing gas that contains more oxygen than air, instead of with air, has the advantage that higher combustion temperatures are reached. Furthermore, the combustion of H₂ may be more complete upon burning with an oxygen containing gas.

In one embodiment of the method, the hydrogen containing gas comprises at least 50 wt. % hydrogen, at least 75 wt. % hydrogen, at least 90 wt. % hydrogen, at least 95 wt. % hydrogen, at least 99 wt. % hydrogen, or at least 99.9 wt. % hydrogen.

In one embodiment of the method, the oxygen containing gas comprises at least 50 wt. % oxygen, at least 75 wt. % oxygen, at least 90 wt. % oxygen, at least 95 wt. % oxygen, at least 99 wt. % oxygen, or at least 99.9 wt. % oxygen.

In one embodiment of the method, heating the glass raw materials and/or the glass melt using a hydrogen burner comprises burning a hydrogen containing gas with an oxygen containing gas, wherein the hydrogen containing gas comprises at least 50 wt. % hydrogen and wherein the oxygen containing gas comprises at least 50 wt. % oxygen, wherein the hydrogen containing gas comprises at least 75 wt. % hydrogen and wherein the oxygen containing gas comprises at least 75 wt. % oxygen, wherein the hydrogen containing gas comprises at least 90 wt. % hydrogen and wherein the oxygen containing gas comprises at least 90 wt. % oxygen, wherein the hydrogen containing gas comprises at least 95 wt. % hydrogen and wherein the oxygen containing gas comprises at least 95 wt. % oxygen, wherein the hydrogen containing gas comprises at least 99 wt. % hydrogen and wherein the oxygen containing gas comprises at least 99 wt. % oxygen, or wherein the hydrogen containing gas comprises at least 99.9 wt. % hydrogen and wherein the oxygen containing gas comprises at least 99.9 wt. % oxygen.

In one embodiment of the method, relating to the burning with oxygen, the oxygen is used from air fractionation and comprises about 95.5 vol. % O₂, 2 vol. % N₂, and 2.5 vol. % Ar. In one embodiment of the method, relating to the burning with an oxygen containing gas, the oxygen containing gas is used from air fractionation and comprises 95.5 to 99.8 vol. % O₂. In one embodiment of the method, relating to the burning with an oxygen containing gas, the oxygen containing gas comprises 95.5 to 99.8 vol. % O₂.

In one embodiment of the method, hydrogen, e.g. 100% H₂, is obtained and/or generated by electrolysis of H₂O. It is generally known that electrolysis of H₂O yields H₂ with high purity and only low amounts of e.g. N₂, noble gases or O₂. The skilled person knows how to assess and/or control the purity of the hydrogen used.

Glass raw materials shall be understood as any chemical component that is suitable, in combination with other similar components, to form a glass melt and, optionally after reactions have taken place in the glass melt, a glass composition and/or a glass product. Examples of glass raw materials used in the context of this disclosure include, but are not limited to, the oxides of metals and metalloids, the nitrates of metals and metalloids, and the carbonates of metals and metalloids.

Where reference is made to a “glass composition” in the context of the method of making a glass composition, it is to be understood as the oxide composition of the glass after melting the batch of glass raw materials including any halogens or halogenides.

In one embodiment of the method, melting a batch of glass raw materials in a melting tank to form a glass melt comprises heating the batch of glass raw materials at least partially to a temperature of T3 or above, wherein T3 relates to a viscosity of the glass melt of 10³ dPa*s.

In one embodiment of the method, heating the glass melt using a hydrogen burner comprises heating the glass such that at least a part of the glass melt has a viscosity of 10^{2.5} dPas or less.

In a further embodiment of the method, heating the glass melt using a hydrogen burner comprises heating the glass melt such that at least a part of the glass melt has a viscosity of 10^{2.5} dPas or less, wherein the average dwelling time at the step “heating the glass raw materials and/or the glass melt” is 2 to 48 h, 4 to 36 h, 8 to 24 h, or 12 to 16 h. In one embodiment of the method, the average dwelling time at the step “heating the glass raw materials and/or the glass melt” is at least 2 h, at least 4, at least 8 h, or at least 12 h. In one embodiment of the method, the average dwelling time at the step “heating the glass raw materials and/or the glass melt” is 48 h or less, 36 h or less, 24 h or less, or 16 h or less.

“Dwelling time” is the time that a given portion of the glass melt spends in a melting tank before being withdrawn from the melting tank. Dwelling time can be measured using so-called tracers, i.e. components that are added to the glass melt so that they can be detected in the product, allowing conclusions as to the time spent in the melting tank. Examples of tracer compounds are Ca, Sr and Y. The “minimum dwelling time” is the time that a portion of glass melt needs to travel through the melting tank taking the fastest path, i.e. the time between addition of an amount of tracer compound into the melting tank and the first occurrence of the tracer in the product. The “average dwelling time” is defined as

$$\frac{melting tank volume [ {m}^{3} ]}{melting tank throughput [ \frac{{m}^{3}}{h} ]} .$$

Advantageously, the melting and/or the heating step in combination with the refining step allows establishing an equilibrium between the glass components and establishes a water content of 10 to 80 mmol/l in the glass melt, and optionally further allows removing bubbles from the melt.

In one embodiment, a glass product comprising a water content of 10 to 80 mmol/l is obtained.

In one embodiment, the glass product has a water content of 10 to 80 mmol/l. In one embodiment, the water content is less than 80 mmol/l, less than 75 mmol/l, less than 70 mmol/l, less than 65 mmol/l, or less than 60 mmol/l. In one embodiment, the water content is at least 10 mmol/l, at least 15 mmol/l, at least 20 mmol/l, at least 25 mmol/l, at least 30 mmol/l, or at least 40 mmol/l. In one embodiment, the water content is 10 to 80 mmol/l, 15 to 75 mmol/l, 20 to 70 mmol/l, 25 to 65 mmol/l, 30 to 60 mmol/l, or 40 to 60 mmol/l. In one embodiment, the glass product has a water content of 20 to 60 mmol/l, or 40 to 55 mmol/l.

In one embodiment of the method, the batch of glass raw materials comprises less than 15 wt. % carbonate, wherein “wt. % carbonate” refers to the mass amount of the CO₃²⁻ species with respect to the amount of the total weight of the batch of glass raw materials.

In one embodiment of the method, the batch of glass raw materials comprises less than 15 wt. % carbonate, less than 5.0 wt. % carbonate, less than 2.0 wt. % carbonate, less than 1.0 wt. % carbonate, less than 0.1 wt. % carbonate, or less than 0.01 wt. % carbonate. In one embodiment of the method, the batch of glass raw materials is essentially free of carbonate.

In one embodiment of the method, the batch of glass raw materials comprises less than 500 ppm SnO₂, less than 100 ppm As₂O₃, and/or less than 100 ppm Sb₂O₃.

In one embodiment, the batch of glass raw materials comprises less than 500 ppm SnO₂, less than 200 ppm SnO₂, less than 100 ppm SnO₂, or less than 50 ppm SnO₂. In one embodiment, the batch of glass raw materials comprises at least 1 ppm SnO₂, at least 5 ppm SnO₂, at least 10 ppm SnO₂, or at least 20 ppm SnO₂. In one embodiment, the batch of glass raw materials comprises at least 1 to 500 ppm SnO₂, 5 to 200 ppm SnO₂, 10 to 100 ppm SnO₂, or 20 to 50 ppm SnO₂.

In one embodiment, the batch of glass raw materials comprises less than 100 ppm As₂O₃, less than 50 ppm As₂O₃, less than 20 ppm As₂O₃, or less than 10 ppm As₂O₃. In one embodiment, the batch of glass raw materials comprises at least 1 ppm As₂O₃, at least 2 ppm As₂O₃, at least 3 ppm As₂O₃, or at least 5 ppm As₂O₃. In one embodiment, the batch of glass raw materials comprises 1 to 100 ppm As₂O₃, 2 to 50 ppm As₂O₃, 3 to 20 ppm As₂O₃, or 5 to 10 ppm As₂O₃.

In one embodiment, the batch of glass raw materials comprises less than 100 ppm Sb₂O₃, less than 50 ppm Sb₂O₃, less than 20 ppm Sb₂O₃, or less than 10 ppm Sb₂O₃. In one embodiment, the batch of glass raw materials comprises at least 1 ppm Sb₂O₃, at least 2 ppm Sb₂O₃, at least 3 ppm Sb₂O₃, or at least 5 ppm Sb₂O₃. In one embodiment, the batch of glass raw materials comprises 1 to 100 ppm Sb₂O₃, 2 to 50 ppm Sb₂O₃, 3 to 20 ppm Sb₂O₃, or 5 to 10 ppm Sb₂O₃.

In one embodiment, the batch of glass raw materials comprises less than 50 ppm SnO₂, less than 10 ppm As₂O₃ and/or less than 10 ppm Sb₂O₃.

In one embodiment, the batch of glass raw materials comprises 1 to 500 ppm SnO₂, 1 to 100 ppm As₂O₃ and/or 1 to 100 ppm Sb₂O₃.

In one embodiment, the batch of glass raw materials comprises 1 to 50 ppm SnO₂, 1 to 10 ppm As₂O₃ and/or 1 to 10 ppm Sb₂O₃.

In one embodiment, the batch of glass raw materials is essentially free of As₂O₃ and Sb₂O₃. Advantageously, the oxide refining agents As₂O₃ and Sb₂O₃ are essentially not present in the batch of glass raw materials in order to reduce the environmental burden associated with the toxic heavy metals As and Sb.

In one embodiment of the method, refining the glass melt is carried out at a temperature T_{ref}, which is at least 1.2 times the boiling temperature of the refining agent at 1 bar, provided that in case of a mixture of refining agents, the refining agent with the highest boiling temperature serves as a reference.

It is preferred that refining the glass melt is carried out at a temperature T_{ref} which is at least 1.00 times, or at least 1.05 times, the boiling temperature of the refining agent. It has been surprisingly found that good refining results are achieved when working within this temperature regime. Hitherto, it was assumed that the refining temperature and the boiling temperature of the refining agent should be fairly equal.

In one embodiment of the method, refining the glass melt comprises maintaining a temperature T_{ref}, which is maximally 1.20 times the boiling temperature of the refining agent at 1 bar, for a time of 2 to 48 h, 4 to 36 h, 8 to 24 h, or 12 to 16 h. In one embodiment of the method, the time is at least 2 h, at least 4, at least 8 h, or at least 12 h. In one embodiment of the method, the time is 48 h or less, 36 h or less, 24 h or less, or 16 h or less. Advantageously, the water content in the glass composition may thereby be reduced below 80 mmol/l.

In one embodiment of the method, the refining agent is selected from the list of chlorides and fluorides, wherein the refining agent is present in the batch of glass raw materials at a content of 1 wt. % or less.

Advantageously, chlorides and fluorides may be used as a (re) fining agent in order to adjust the water content in the glass composition and to remove emanating gas bubbles from the glass melt. It is further advantageous to reduce the amount of chlorides and fluorides in the glass melt in order to reduce volatile species emanating from the glass melt by sublimation.

In one embodiment of the method, the refining agent is selected from the list of NaCl, KCl, NaF and KF, wherein the refining agent is present at a content of 1.00 wt. % or less, with respect to the batch of glass raw materials.

In one embodiment of the method, the refining agent selected from the list of chlorides and fluorides is present at a content of 1.0 wt. % or less, 0.75 wt. % or less, 0.50 wt. % or less, 0.40 wt. % or less, 0.30 wt. % or less, or 0.20 wt. % or less, with respect to the batch of glass raw materials. In one embodiment, the refining agent selected from the list of chlorides and fluorides is present at a content of 0.01 wt. % or more, 0.02 wt. % or more, 0.03 wt. % or more, 0.05 wt. % or more, 0.07 wt. % or more, or 0.10 wt. % or more, with respect to the batch of glass raw materials. In one embodiment, the refining agent selected from the list of chlorides and fluorides is present at a content of 0.01 wt. % to 1.0 wt. %, 0.02 wt. % to 0.75 wt. %, 0.03 wt. % to 0.50 wt. %, 0.05 wt. % to 0.40 wt. %, 0.07 wt. % to 0.30 wt. %, or 0.10 wt. % to 0.20 wt. %, with respect to the batch of glass raw materials.

In one embodiment of the method, the refining agent is selected from the list of NaCl, KCl, NaF and KF, wherein the refining agent is present at a content of 0.01 wt. % to 1.0 wt. %, 0.02 wt. % to 0.75 wt. %, 0.03 wt. % to 0.50 wt. %, 0.05 wt. % to 0.40 wt. %, 0.07 wt. % to 0.30 wt. %, or 0.10 wt. % to 0.20 wt. %, with respect to the batch of glass raw materials.

In one embodiment of the method, the glass melt has a viscosity of 10² dPas at a temperature above 1580° C., and/or the glass melt is heated to a temperature high enough that at least a part of the glass melt has a viscosity of 10^{2.5} dPas or less.

Advantageously, a glass melt with a viscosity of 10^{2.5} dPas or less allows for escape of a major portion of gases in the glass melt. It is of particular advantage when fining agents are used as part of the glass raw materials since their evaporation and/or decomposition (at a certain temperature) leads to the formation of gas. Due to partial pressure differences, any gases present in the melt diffuse into the (re) fining agent gas bubbles which grow and rise to the top of the melt. At a sufficiently low viscosity of the glass melt, rise of the gas bubbles to the top of the glass melt is facilitated and/or accelerated.

In one embodiment, the glass product is a sheet, a wafer, a plate, a tube, a rod, an ingot or a block.

In one embodiment, the glass product has a total carbon content of less than 310 ppm, based on the weight of the carbon atoms with respect to the weight of the glass product.

In one embodiment, the glass product has a total carbon content of less than 310 ppm, based on the weight of the carbon atoms with respect to the weight of the glass product. Optionally, the glass product has a total carbon content of less than 310 ppm, based on the weight of the carbon atoms with respect to the weight of the glass product. In a further embodiment, the glass product has a total carbon content of less than 160 ppm, less than 80 ppm, or less than 30 ppm, based on the weight of the carbon atoms with respect to the weight of the glass product. In a further embodiment, the glass product has a total carbon content of at least 1 ppm, at least 2 ppm, at least 3 ppm, or at least 5 ppm, based on the weight of the carbon atoms with respect to the weight of the glass product. In a related embodiment, the glass product has a total carbon content of from 1 to 310 ppm, from 2 to 160 ppm, from 3 to 80 ppm, or from 5 to 30 ppm, based on the weight of the carbon atoms with respect to the weight of the glass product. A glass product having a limited total carbon content as described herein, based on the weight of the carbon atoms with respect to the weight of the glass product, advantageously has fewer bubbles present in the (obtained) glass product and/or has fewer CO₂ bubbles present in the (obtained) glass product.

In one embodiment, the obtained glass product comprises less than 0.2 wt. % chlorine and/or less than 0.2 wt. % fluorine, preferably comprises 0.02 to 0.2 wt. % of chlorine and/or 0.02 to 0.2 wt. % of fluorine.

### CO₂ Solubility

The CO₂ solubility has been measured by vacuum hot extraction after saturation, respectively equilibration, with a defined CO₂ partial pressure (cf. PhD thesis of Christopher Charles Tournour, “Solubility and Diffusion of Gases in Glasses and Melts”, Alfred University, New York, 2004, chapters 3.2 to 3.4). To this end an apparatus for the saturation of glasses and melts under controlled temperatures and pressures has been used. The apparatus consists of 1½ inch stainless steel vacuum fittings with copper gasket seals. The saturation chamber was either a vitreous silica or mullite tube depending on the saturation temperature used. Gas was supplied to the sample through ¼ inch stainless steel tubing. Swagelock® fittings were used throughout the apparatus. The saturation chamber was evacuated with a direct drive mechanical pump, and the pump pressure was monitored by a thermocouple pressure gauge. A vertically sliding electric resistance furnace was used to heat the vitreous silica saturation chamber, whereas a stationary electric resistance furnace must be used with the mullite tubes due to the greater chance of thermally shocking this material. A type-K thermocouple placed within 1 inch of the specimen was used to monitor the temperature of the glass in the vitreous silica tube, while a digital monometer was used to monitor the system pressure. A type-K thermocouple was used to monitor the temperature in the mullite tube, and was removed prior to saturation of the sample in order to allow enough room for the crucible to be lowered into the tube. A digital monometer was used to monitor the system pressure.

Melt samples are saturated by placing a cube of glass (2 to 4 grams) into a Pt/5Au crucible. The crucible is inserted into a platinum cradle suspended from the top of the saturation chamber by platinum wire. This configuration is then lowered into a mullite tube attached to the saturation system and surrounded by a furnace preheated to approximately 1100° C. Samples are allowed to equilibrate at this temperature while a vacuum is drawn stepwise in 100 Torr increments in order to remove the ambient atmosphere in the tube as well as remove any residual gases and bubbles in the melt. It is necessary to draw the vacuum slowly to avoid foaming of the melt from these gas sources. The furnace temperature is then changed to the desired saturation temperature and the remelted sample is allowed to equilibrate at this new temperature. Once equilibrated, the saturation chamber is filled to the desired pressure with the gas of interest. Melts are held at temperature and pressure for enough time to reach equilibrium after which the dissolved gas is frozen into the sample by rapidly removing the crucible from the saturation chamber and quenching it in water.

Detection of gases that evolved from a sample was performed with a quadrupole mass spectrometer, or a residual gas analyzer (RGA). The gases were introduced to the RGA through a metering valve that controls the rate of gas flow from the sample to the mass spectrometer. A port also exists for introducing gas from a standard volume container in order to calibrate the system and determine absolute gas solubilities.

Outgassing of glasses and melts is carried out by placing a sample in a new platinum crucible not previously exposed to the saturating gas. This crucible is then lowered into the vitreous silica tube attached to the outgassing apparatus. Prior to loading the sample chamber, the vitreous silica tube is heated under vacuum and outgassed to ensure that the only gas detected by the RGA is from the sample. The system is evacuated to approximately 10-7 Torr in order to remove any ambient atmosphere and five minutes of background data are collected with the RGA before a furnace preheated to the desired outgassing temperature is raised over the sample. Glasses melts were outgassed at 950° C. Specimens were held at temperature long enough for all of the dissolved gas to diffuse out of the glass or melt and into the mass spectrometer system.

### Carbon Content

The carbon content has been quantified by IR gas analysis after combustion according to DIN 51085:2015-01, which describes an analogous sulphur content quantification after combustion.

### EXAMPLES

### Glass Products

One representative glass composition relating to a pharmaceutical glass according to this disclosure was investigated.

The glass was manufactured by melting. For comparison, the glass was manufactured by (a) 100% fossil fuel heating based on burning natural gas with oxygen, and (c) by 100% H₂ burning with oxygen.

### Water Content of the Glasses

To assess the water content, the glasses were manufactured by (a) fossil fuel heating based on burning natural gas with oxygen, or (b) by exclusive electric heating in the melting step.

The water content of the pharmaceutical glass was 58.3 mmol/l (a) and 58.0 mmol/l (b).

### Contact Angle Measurements

The contact angle between a glass and a PtRh alloy interface was measured according to DIN 51730:2007-09. The used PtRh alloy was PtRh10.

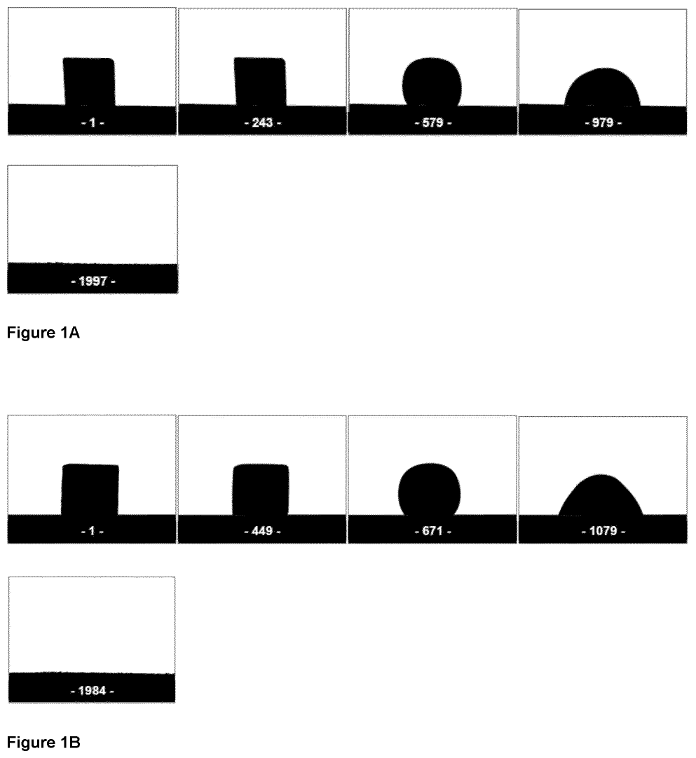

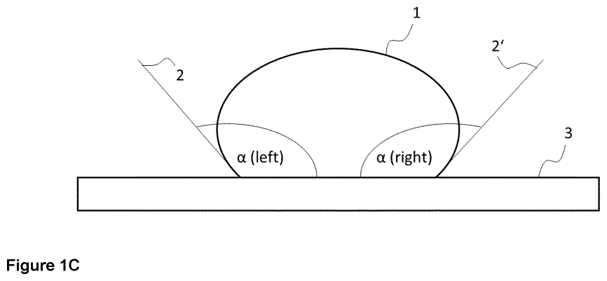

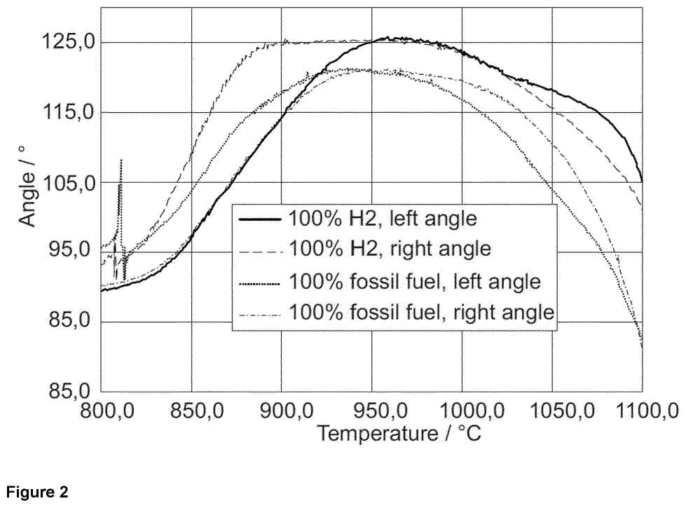

During each measurement, a glass (cube) sample with an edge length of 2.5 mm is placed on a PtRh10 alloy interface and continuously heated and monitored by photographic imaging (cf. FIGS. 1A, 1B, 1C). The temperature of the sample is measured directly underneath the sample at a distance of 2 mm. The uncertainty of the temperature measurement is determined by calibration against the melting point of gold (Au) and was found to be between 4 and 5 K. Image analysis provides for consecutive time points (i.e. related temperatures) and yields a left contact angle and a right contact angle, from which the characteristic temperatures DT (softening temperature), ST (spherical temperature), HT (hemisphere temperature) and FT (flowing temperature) can be obtained. Both the left contact angle and the right contact angle are determined with the aid of image analysis software and are the result of a tangential fit which is related to (i.e. equated to) the baseline of the PtRh10 alloy interface (FIG. 1C). During the heating of the glass (cube) sample through the characteristic temperatures DT, ST, HT and FT, the left and right contact angle is initially around 90°, will then rise to values above 90° and eventually become less than 90°. From each data curve, i.e. the data curve for the left contact angle and the right contact angle, the maximal contact angle is extracted as a characteristic parameter (cf. FIG. 2).

The below table summarises the measured data for the glass produced by either natural gas burning or hydrogen burning as a fuel. FIG. 1 shows the temperature dependence of the glass produced by either natural gas burning or hydrogen burning as a fuel.

| | | | Contact | | Characteristic | | | |
|---|---|---|---|---|---|---|---|---|
| | | | angle (°) | | temperatures (° C.) | | | |
| Glass | Alloy | Fuel | Left | Right | DT | ST | HT | FT |
| Boro- | PtRh10 | 100% gas | 121 | 121 | 766 | 905 | 1102 | |
| silicate | | 100% H₂ | 125 | 125 | 828 | 923 | 1167 | |

The number of bubbles with more than 10 vol % of CO₂ per 10 kg, and a bubble size of more than 100 μm was six for gas-heated samples and zero for H₂-heated samples. The number of bubbles with more than 5 vol % of CO₂ per 10 kg, and a bubble size of more than 100 μm was six for gas-heated samples and zero for H₂-heated samples.

1. Glass product or glass composition comprising a total carbon content of less than 310 ppm, based on the weight of the carbon atoms with respect to the weight of the product or the composition, and/or comprising less than 2 bubbles having a size of 100 μm or more and a CO₂ content of more than 10% relative to the total volume of gas in the bubble, per 10 kg of glass,
wherein the product or composition has a water content of 10 to 80 mmol/l, wherein a maximal contact angle between a glass/PtRh interface, is more than 122.0°, preferably more than 124.0°, measured according to DIN 51730:2007-09.

2. Glass product or glass composition according to claim 1, further
comprising a refining agent selected from the list of chlorides and fluorides, wherein the refining agent is present at a content of 1.00 wt. % or less, preferably comprising less than 0.60 wt. % chlorine and/or less than 0.30 wt. % fluorine, with respect to the weight of the product or composition, and/or
having less than 80 bubbles in a size range of from 0.1 mm to 0.2 mm per 10 kg of glass and/or less than 2 bubbles of a size larger than 0.2 mm per 10 kg of glass.

3. Glass product or glass composition according to claim 1, being free of bubbles having a size of 100 μm or more and a CO₂ content of more than 10% relative to the total volume of gas in the bubble, per 10 kg of glass.

4. Glass product or glass composition according to claim 1, exhibiting a viscosity of 10² dPas at a temperature above 1580° C.

5. Glass product or glass composition according to claim 1, wherein the hemisphere temperature of the glass product or glass composition is 1000 to 1300° C., measured according to DIN 51730:2007-09.

6. Glass product or glass composition according to claim 1, comprising less than 500 ppm SnO₂, less than 100 ppm As₂O₃, and/or less than 100 ppm Sb₂O₃.

7. Glass product or glass composition according to claim 1, wherein the product or composition has a water content of 20 to 60 mmol/l, preferably 40 to 55 mmol/l.

8. Glass product or glass composition according to claim 1, comprising the following components in % by weight

| | |
|---|---|
| SiO₂ | 70.0 to 87.0 |
| B₂O₃ | 7.0 to 25.0 |
| Al₂O₃ | 0.0 to 15.0 |

or the product or composition comprising the following components in % by weight

| | |
|---|---|
| SiO₂ | 70.0 to 87.0 |
| B₂O₃ | 7.0 to 25.0 |
| Na₂O + K₂O | 0.5 to 15.0 |
| Al₂O₃ | 0.0 to 15.0 |
| CaO | 0.0 to 3.0 |

or the product or composition comprising the following components in % by weight

| | |
|---|---|
| SiO₂ | 70.0 to 85.0 |
| Al₂O₃ | 0.0 to 10.0 |
| B₂O₃ | 7.0 to 20.0 |
| Na₂O | 3.0 to 15.0 |
| K₂O | 0.0 to 3.0 |
| ZnO | 0.0 to 12.0 |
| TiO₂ | 0.5 to 10.0 |
| CaO | 0.0 to 2.0 |

9. Glass product or glass composition according to claim 1, comprising less than 0.40 mg/l CaO in an eluate prepared and analysed according to ISO 720:1985.

10. Glass product or glass composition according to claim 1, having a CO₂ solubility in a glass melt of less than 5·10¹⁹ molecules CO₂ bar⁻¹ cm⁻³ at 1100° C., and/or having a temperature dependence of the CO₂ solubility in the glass melt which exceeds 2·10¹⁴ molecules CO₂ bar⁻¹ cm⁻³ K⁻¹ in a temperature range of from 1000 to 1600° C.

11. Glass product according to claim 1, being a sheet, a wafer, a plate, a tube, a rod, an ingot or a block.

12. Method of making a glass product, comprising the steps of
melting a batch of glass raw materials in a melting tank to form a glass melt,
heating the glass raw materials and/or the glass melt using a hydrogen burner, preferably using exclusive heating by way of hydrogen burning,
refining the glass melt using a refining agent,
withdrawing the glass melt from the melting tank,
obtaining a glass product comprising a water content of 10 to 80 mmol/l,
wherein the batch of glass raw materials comprises less than 15 wt. % carbonate.

13. Method according to claim 12, wherein the batch of glass raw materials comprises less than 500 ppm SnO₂, less than 100 ppm As₂O₃, and/or less than 100 ppm Sb₂O₃.

14. Method according to claim 12, wherein refining the glass melt is carried out at a temperature T_{ref}, which is at least 1.2 times the boiling temperature of the refining agent at 1 bar, provided that in case of a mixture of refining agents is used, the refining agent with the highest boiling temperature serves as a reference.

15. Method according to claim 12, wherein the refining agent is selected from the list of chlorides and fluorides, wherein the refining agent is present in the batch of glass raw materials at a content of 1 wt. % or less.

16. Method according to claim 12, wherein
the glass melt has a viscosity of 10² dPas at a temperature above 1580° C., and/or
the glass melt is heated to a temperature high enough that at least a part of the glass melt has a viscosity of 10^{2.5} dPas or less.

17. Method according to claim 12, wherein
the glass product is a sheet, a wafer, a plate, a tube, a rod, an ingot or a block; and/or
the glass product has a total carbon content of less than 310 ppm, based on the weight of the carbon atoms with respect to the weight of the glass product.
